(19) United States
(12) Patent Application Publication
(10) Pub. No.: US 2007/0140649 A1
(43) Pub. Date: Jun. 21, 2007

(54) INFORMATION RECORDING AND REPRODUCING APPARATUS WITH FUNCTION OF VIDEO RECORDING RESERVATION AND INFORMATION RECORDING AND REPRODUCING METHOD

(75) Inventors: Hirotake ANDO, Tokyo (JP); Katsuya Yamazaki, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/608,989

(22) Filed: Dec. 11, 2006

(30) Foreign Application Priority Data
Dec. 19, 2005 (JP) 2005-364813

(51) Int. Cl. H04N 5/91

(52) U.S. Cl. 386/83

(57) ABSTRACT

Provided is a technique to eliminate a waste of a recording capacity due to redundant video recording reservations. When the video recording reservations made by a plurality of users overlap one another at least in part, video recording information in an overapping part of the video recording reservations is jointly owned and recorded.

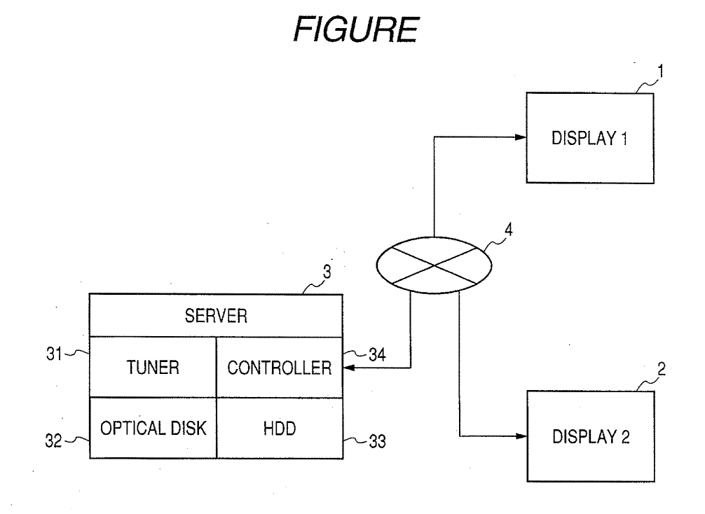

### BACKGROUND OF THE INVENTION

1. Field of the Invention

The present invention relates to an information recording and reproducing apparatus and an information recording and reproducing method each capable of reserving video recording.

2. Description of the Related Art

In recent years, there has been developed a large-capacity information recording and reproducing apparatus, such as an HDD or a DVD recorder, for receiving and recording a broadcasting program, or for recording and storing images taken by a digital camera, a video camera, or the like.

With a use of the apparatus, a user can reserve video recording of a broadcasting program, record images taken by the user through a digital camera, a video camera, or the like into an HDD or a DVD, or reproduce the video images thus recorded.

Also, the user can copy data from the HDD into the DVD, or delete video images after viewing the video images.

Further, the user can determine image quality of an image to be recorded depending on the purpose of the image recording, and record images at a recording rate corresponding to the image quality.

Also, toward the future, the above-mentioned large-capacity information recording and reproducing apparatus such as an HDD or a DVD recorder may be used for a server for sending and receiving data to and from a site to which the apparatus is connected through a network and for storing the received data, and the development on the apparatus is also being made.

However, the above-mentioned large-capacity information recording and reproducing apparatus such as an HDD or a DVD recorder is merely designed on the assumption that a single user uses the apparatus, with little consideration given to a case where a plurality of users use the apparatus.

For example, there has been given no consideration at all to a case where a plurality of users reserve the same broadcasting program but with different image qualities, or with slightly different timings of starting and ending the video recording.

When one of the users is to reproduce the program recorded by the user, the user may have difficulty in selecting the information that the user wants to see because a list for reproduction includes other programs recorded by other users, or the user may mistakenly delete the other programs recorded by the other users.

### SUMMARY OF THE INVENTION

According to the present invention, there is provided an information recording and reproducing apparatus capable of reserving video recording, comprising: a tuner for receiving a broadcasting program; recording means for performing video recording the broadcasting program; and a controller for managing video recording reservations and controlling the recording means, wherein the controller jointly owns and records video recording information in an overlapping part of the video recording reservations when contents of the video recording reservations made by a plurality of users overlap one another at least in part.

Also, according to the present invention, there is provided a method of recording and reproducing information capable of reserving video recording, comprising the steps of: receiving a video recording reservation; and jointly owning and recording video recording information in an overapping part of the video recording reservations when the content of the video recording reservation overlaps at least a part of a content of another video recording reservation which has already been accepted.

Further features of the present invention will become apparent from the following description of exemplary embodiments with reference to the attached drawing.

### BRIEF DESCRIPTION OF THE DRAWING

FIGURE is a block diagram showing a structure of an information recording and reproducing apparatus according to an embodiment of the present invention.

### DESCRIPTION OF THE EMBODIMENTS

Hereinafter, a best mode for carrying out the present invention is described with reference to the accompanying drawing.

FIGURE is a block diagram showing a structure of an information recording and reproducing apparatus according to an embodiment of the present invention.

In FIGURE, the information recording and reproducing apparatus of this embodiment includes displays 1 and 2, and a server 3.

The displays 1 and 2 are placed at different places.

The server 3 has at least one tuner 31, an optical disk drive device 32 capable of recording and reproducing data, and a hard disk device 33. The server 3 is controlled by a controller 34.

The two displays 1 and 2, and the server 3 are connected to one another through a network 4.

The displays 1 and 2 each have an ID assigned thereto, the ID being different from each other. The displays 1 and 2 each are controlled by a user, respectively, through a remote controller or the like (not shown) provided to each of the displays.

The controller 34 in the server 3 has a stored-information list and a video recording reservation list, and manages the lists. The stored-information list includes all the information stored in each of the optical disk device 32 and the hard disk device 33 in the server 3, and the video recording reservation list is used for reserving video recording.

The stored-information list and the video recording reservation list are in the form of, for example, a table shown in the following.

| | | | Image | Storage | | Date and time for | Date and time for ending |
|---|---|---|---|---|---|---|---|
| No. | ID | Title | quality | area | Channel | starting video recording | video recording |
| Stored-information list | | | | | | | |
| 1 | 1 | AABBB | SP | HDD | 1 | 2004/12/20/08:15:00 | 2004/12/20 08:30:00 |
| 2 | 2 | CCCCA | LP | HDD | 8 | 2004/12/20/19:00:00 | 2004/12/20 20:00:00 |
| 3 | 2 | DDDDD | LP | ODD | 12 | 2004/12/20/21:00:00 | 2004/12/20 22:54:30 |
| 4 | 1 | AACCC | SP | ODD | 3 | 2004/12/20/21:15:00 | 2004/12/20 22:00:03 |
| 5 | 2 | DDBBC | SP | HDD | 1 | 2004/12/21/08:15:00 | 2004/12/21 08:30:00 |
| 6 | 2 | DDCCA | SP | HDD | 8 | 2004/12/21/12:20:05 | 2004/12/21 12:50:05 |
| 7 | 1 | BBCCC | LP | HDD | — | 2004/12/21/12:54:30 | 2004/12/21 13:03:30 |
| 8 | 1, 2 | CCBDD | SP | HDD | 1 | 2004/12/22/08:15:00 | 2004/12/22 08:30:00 |
| 9 | 1 | BBDAD | LP | ODD | 10 | 2004/12/22/22:54:30 | 2004/12/22 22:59:30 |
| 10 | 2 | CCDBB | SP | HDD | 1 | 2004/12/23/08:15:00 | 2004/12/23 08:30:00 |
| 11 | 1, 2 | ADBCA | LP | HDD, ODD | 10 | 2004/12/23/22:54:30 | 2004/12/23 22:59:30 |
| 12 | | | | | | | |
| Video recording | | | | | | | |
| reservation list | | | | | | | |
| 1 | 2 | AABBB | SP | ODD | 6 | 2004/12/20/08:15:00 | 2004/12/20 08:30:00 |
| 2 | 2 | CCCCA | LP | HDD | 8 | 2004/12/20/19:00:00 | 2004/12/20 20:00:00 |
| 3 | 2 | DDDDD | LP | ODD | 12 | 2004/12/20/21:00:00 | 2004/12/20 22:54:30 |
| 4 | 1 | AACCC | SP | ODD | 3 | 2004/12/20/21:15:00 | 2004/12/20 22:00:03 |
| 5 | 2 | DDBBC | SP | HDD | 1 | 2004/12/21/08:15:00 | 2004/12/21 08:30:00 |
| 6 | 2 | DDCCA | SP | HDD | 8 | 2004/12/21/12:20:05 | 2004/12/21 12:50:05 |
| 7 | 1 | BBCCC | LP | HDD | 10 | 2004/12/21/22:54:30 | 2004/12/21 22:59:30 |
| 8 | 1 | CCBDD | SP | HDD | 1 | 2004/12/22/08:15:00 | 2004/12/22 08:30:00 |
| 9 | 1 | BBDAD | LP | HDD | 10 | 2004/12/22/22:54:30 | 2004/12/22 22:59:30 |
| 10 | 2 | CCDBB | SP | HDD | 1 | 2004/12/23/08:15:00 | 2004/12/23 08:30:00 |
| 11 | 1 | ADBCA | LP | HDD, ODD | 10 | 2004/12/23/22:54:30 | 2004/12/23 22:59:30 |
| 12 | | | | | | | |

For example, an item No. 1 in the stored-information list indicates that a user of an ID number “1” records information with a title of “AABBB”. Specifically, a program on a channel “1” is to be recorded on the HDD (hard disk) 33 with image quality of “SP” from 08:15:00′ of Dec. 20, 2004 to 08:30:00′ of Dec. 20, 2004.

Although not shown in the table, the stored-information may also record, other than the above information, address information of at least one of the HDD and the ODD storing actual data or a size of the data.

The item No. 1 in the video recording reservation list indicates that a user of an ID number “2” records the information with the title of “AABBB”. Specifically, a program on a channel “6” is to be recorded on the ODD (optical disk) 32 with image quality of “SP” from 08:15:00′ of Dec. 20, 2004 to 08:30:00′ of Dec. 20, 2004.

In either of the lists, a plurality of items of information may be recorded under the headings of “ID” and “storage area”.

First, an explanation is given of a case of reproducing information.

A user in front of the display 1 operates the display 1 through the remote controller or the like so as to cause the display 1 to display a reproduction list which is used for reproducing stored information.

Operation information on the details of the operation is sent, together with the ID of the display 1, to the sever 3 through the network 4.

The controller 34 in the server 3 refers to the operation information sent thereto so as to extract, from the list including all the information stored in the server 3, only a list of items of information stored under the ID of the display 1. The controller 34 sends the extracted items of information as a reproduction list back to the display 1 through the network 4.

For example, if the display 1 is assigned an ID number “1”, the items under the ID “1” are extracted from all the items stored in the stored-information list of the table. That is, the rows of No. 1, 4, 7, 8, 9, and 11 are extracted.

The user selects an item of information to be reproduced, among the items in the reproduction list displayed on the display 1.

The item of information thus selected is sent to the server 3, together with the ID of the display 1, through the network 4.

For example, if the user has selected an item of information corresponding to the item No. 1 in the list of the table, the controller 34 in the server 3 refers to the sent ID and the selected item of information to thereby send compressed reproduction data corresponding to the selected item of information (with title of “AABBB”) to a display associated with the ID through the network 4. Note that the compressed reproduction data is read out from a storage area, that is, the HDD (hard disk), and sent to the display.

Alternatively, if the user has selected an item of information corresponding an item No. 4 in the list of the table, the controller 34 in the server 3 refers to the sent ID and the selected item of information to thereby read out compressed reproduction data corresponding to the selected item of information (with title of “AACCC”) from a storage area, that is, the ODD (optical disk), and sends the data to a display associated with the ID through a network 4.

Upon receiving the compressed reproduction data sent through the network 4, the display 1 decodes the compressed reproduction data by using a decoder (not shown) in the device, and displays the reproduction data.

In the manner as described above, the stored information can be reproduced.

When a user wants to see a broadcasting program, the user in front of the display 1 operates the display 1 through a remote controller or the like to cause the display 1 to display a current program listing.

Operation information on the is sent to the server 3, together with the ID of the display 1, through the network 4.

Then, the controller 34 in the server 3 sends the current program listing of broadcasting programs back to the display 1 through the network 4.

The user selects an item of information to be reproduced among the programs listed in the listing displayed on the display 1.

The selected information is sent to the server 3, together with the ID of the display 1, through the network 4.

Based on the sent ID and the selected information, the controller 34 in the server 3 tunes the settings of the tuner 31 into the program corresponding to the selected information, and sends the data corresponding to the selected information from the tuner 31 to the display associated with the ID through the network 4.

In a case where the selected broadcasting program is in analog form, the program is subjected to compression processing in the server, and sent as compressed data through the network 4.

In the manner as described above, the broadcasting program can be reproduced.

In order to reserve video recording, a user in front of the display 1 operates the display 1 through a remote controller or the like to cause the display 1 to display a program listing for video recording.

Information on the operation is sent to the server 3, together with the ID of the display 1, through the network 4.

Then, the controller 34 in the server 3 sends, in return, the program listing of broadcasting programs to the display 1 through the network 4.

The user selects an item of information to be reserved for video recording, among the programs listed in the listing displayed on the display 1, and also selects the storage area and the image quality for the video recording.

The selected information is sent to the server 3, together with the ID of the display 1, through the network 4.

The controller 34 in the server 3 adds the sent ID and the selected information to the video recording reservation list in which all the video recording reservations in the server 3 are listed.

For example, the item No. 4 in the video recording reservation list in the table is the item additionally included in the list. According to the item No. 4, it is indicated that the ID number of the display is “1”, and a program with a title of “AACCC” on a broadcast channel 3 is selected. The broadcast time is from 21:15:00′ of Dec. 20, 2004 to 22:00:03′ of Dec. 20, 2004. The selected image quality is SP, and the storage area is the ODD.

At the set reservation time, the server 3 tunes the mounted tuner 31 into the reserved program, and records data on the program sent from the tuner into the selected storage area by compressing the data with the set image quality.

In the earlier example, the data is recorded on the ODD (optical disk). In a case where the HDD is designated as the storage area, the data is recorded on the HDD (hard disk).

Upon the start of the recording, the controller 34 in the server 3 adds the information on the program together with the ID and the storage area (HDD or the optical disk) to the list of all the data stored in the server 3.

For example, the information is added as the item No. 4 in the stored-information list of the table.

It should be noted that, at the video recording start time, the item has only the recording start time set thereto. It is not until the recording is finished that the item is updated for a predetermined time during which the normal recording is performed, to thereby allow the stored-information list to be referred to and the program to be reproduced even during the video recording.

In the manner as described above, the video recording is reserved.

After that, the user can reproduce the information on the recorded program in the aforementioned manner.

Explained next is a case of deleting information on a program or the like which has already been watched.

A user in front of the display 1 operates the display 1 through a remote controller or the like to cause the display 1 to display the reproduction list, in order to delete the information stored up to that time.

Operation information is sent to the server 3, together with the ID of the display 1, through the network 4.

The controller 34 in the server 3 refers to the operation information to extract the items of information stored under the ID of the display 1 from the list which includes all the items of information stored in the server, and sends the extracted items of information back to the display 1 through the network 4.

For example, if the display 1 is assigned an ID number “1”, the items under the ID “1” are excerpted from all the items stored in the stored-information list of the table. That is, the rows of No. 1, 4, 7, 8, 9, and 11 are extracted.

The user selects an item of information to be deleted, among the items in the reproduction list displayed on the display 1.

The item of information thus selected is sent to the server 3, together with the ID of the display 1, through the network 4.

For example, if the user has selected an item of information corresponding to the item No. 1 in the list of the table, the controller 34 in the server 3 refers to the sent ID and the selected item of information to thereby delete compressed reproduction data corresponding to the selected item of information (with title of “AABBB”) from the storage area, that is, the HDD (hard disk), as well as to delete the data of No. 1 from the stored-information list.

The controller 34 in the server 3 sends the reproduction list from which the selected item of information is deleted to the display associated with the ID through the network 4.

For example, the list only includes the items No. 4, 7, 8, 9, and 11 when the items relating to the ID number “1” after the item No. 1 is deleted, and therefore the rows of No. 4, 7, 8, 9, and 11 are extracted to be sent to the display.

The user referring to the display on the display 1 confirms that the selected item has been deleted from the list.

In the manner as described above, the stored information can be deleted.

Next, in order to copy or transfer the data onto the optical disk, a user in front of the display 1 operates the display 1 through a remote controller or the like to cause the display to display the reproduction list, in order to copy or transfer the information stored until that time from the HDD to the optical disk.

Operation information is sent to the server 3, together with the ID of the display 1, through the network 4.

Based on the operation information, the controller 34 in the server 3 extracts the items stored under the ID of the display 1 from the list which includes all the information stored in the server, and sends the extracted items as a list to the display 1 through the network 4.

For example, if the display 1 is assigned an ID number “1”, the items under the ID “1” are excerpted from all the items included in the stored-information list of the table. That is, the rows of No. 1, 4, 7, 8, 9, and 11 are extracted.

The user selects an item of information to be copied and transferred, among the items in the reproduction list displayed on the display 1, and designates the destination of the copy and transfer.

The item of information thus selected is sent to the server 3, together with the ID of the display 1, through the network 4.

For example, if the user has selected an item of information corresponding to the item No. 1 in the list of the table while designating the ODD (optical disk) as the copy destination. The controller 34 in the server 3 refers to the sent ID and the selected item of information to thereby additionally designates the ODD (optical disk) as the storage area information to be associated with the corresponding item of information (in this case, item No. 1) among all the items included in the reproduction list. At the same time, the controller 34 copies the actual information from the HDD to the optical disk.

In addition to the above, if there is any other items of information relating to the storage area, for example, information on an address or a data size, the information is also updated.

The list after the copy has at least the items under the headings of “storage area” changed to “HDD, ODD”.

In a case of transferring the data, “ODD” (optical disk) is additionally provided as the information on the storage area regarding the corresponding item of information in the reproduction list and “HDD” is deleted therefrom. The actual data in the HDD is deleted only after the data is copied to the optical disk from the HDD.

The list after the transfer only includes “ODD” as items under the headings of “storage area”

The controller 34 sends the reproduction list in which “ODD (optical disk)” is added to the selected information to the display associated with the ID through the network 4.

The user referring to the display on the display 1 confirms that the data has been copied or transferred. (In the list, the item No. 1 includes “ODD” as the item under the “storage area”, which has been additionally provided as the item or has replaced the previous item.)

In the manner as described above, the stored information can be copied or transferred to the optical disk.

It is also possible to copy and transfer the data from the ODD (optical disk) to the HDD in the similar manner by interchanging the copy/transfer destination and the copy/transfer source.

Explained next is a case of recording information obtained through a digital camera or the like on the server.

A user in front of the display 1 connects the digital camera to the display 1 through, for example, IEEE1394, and operates the display 1 through a remote controller or the like such that the information is recorded on the server 3.

Operation information is sent to the server 3, together with the ID of the display 1, through the network 4.

The controller 34 in the server 3 receives the recorded data from the display 1 and, based on the operation information, adds the image information of the digital video camera and the ID to the reproduction list including all the information, while starting recording the information on the HDD.

For example, an item No. 7 in the stored-information list of the table represents the information thus added.

The recorded information can be reproduced based on the reproduction list.

In this example, operation of recording the information obtained through a digital video camera is explained, but the same operation can be applied for recording the information obtained through a digital camera.

Explained next is a case where a plurality of users reserve the same broadcasting program for video recording.

A certain broadcasting program has been reserved for video recording by a certain user 1 through the display 1. The method of reserving video recording has already been described in the above.

Next, a user 2 in front of the display 2 operates the display 2 through a remote controller or the like to cause the display 2 to display a program listing for video recording.

Operation information is sent to the server 3, together with the ID of the display 2, through the network 4.

The controller 34 in the server 3 sends the program listing of broadcasting programs back to the display 2 through the network 4.

The user 2 selects an item of information to be reserved for video recording among the programs listed in the listing displayed on the display 2, and also determines image quality for the video recording.

The selected information is sent to the server 3, together with the ID of the display 2, through the network 4.

The controller 34 tries to add the sent ID and the selected information to the video recording reservation list which includes all the video recording reservations in the server 3.

However, if the video recording reservation list is provided as the one shown in the table, the program to be reserved for video recording by the user 2 (hereinafter, referred to as ID2) is the same as the one which has already been reserved by the user 1 of ID1 which is shown as an item No. 8 in the list.

In this case, the controller 34 detects that the same program has already been reserved under a different ID (in this case, display 1).

The controller 34 adds the ID of the display 2 to the corresponding program among the programs reserved under the ID of the display 1 in the video recording reservation list.

That is, the controller 34 adds “ID2” to the item under “ID” of the item No. 8 in the video recording reservation list of the table.

At this time, if the image quality selected by the user 1 is “SP” as shown in the item No. 8 of the table while the image quality selected by the user 2 is “LP”, the user 1 who selected higher image quality is assigned priority, and the recording is performed with image quality SP.

For example, LP assumes an average transfer rate of about 2 Mbps while SP assumes about 5 Mbps, and therefore, the image quality is further improved with SP which has a higher transfer rate than LP.

At the set reservation time, the controller 34 tunes the tuner mounted to the reserved program, and records data on the program sent from the tuner 31 on an HDD with a set image quality.

In a case where the optical disk has been designated as the recording destination, the data is recorded on the optical disk.

Upon starting the recording, the controller 34 additionally provide information that the recording is started, together with the two IDs (of displays 1 and 2), to the stored-information list including all the information stored in the server 3.

For example, as shown in the item No. 8 in the stored information list of the table, the two IDs are recorded as the items under “ID”.

In other words, the data to be recorded according to the video recording reservation is only one kind, while being assigned two IDs merely under the list.

When the reproduction list is displayed upon request of each of the users 1 and 2 for reproduction of the reserved program, each list includes the information on the reserved program.

By taking the stored-information list of the table as an example, the reproduction list displayed for the user 1 includes only the items No. 1, No. 4, No. 7, No. 8, No. 9, and No. 11. The reproduction list displayed for the user 2 includes only the items No. 2, No. 3, No. 5, No. 6, No. 8, No. 10, and No. 11.

When the item of data is deleted by one of the users, only the ID of the user is deleted from the reproduction list including all the information on the server, and the ID of the other user still remains.

In this way, the reproduction list for the user who has deleted the item of information does not include the information, while the reproduction list for the user who did not deleted the information still includes the information.

The data is actually deleted only after the data is deleted by both of the users.

In the above example, the start time and the ending time for the video recording are the same between the reservations. A case where the start time and the ending time are different between the reservations is explained.

For example, a user 1 with ID1 has already reserved a program indicated as the item No. 8 in the video recording reservation list.

Next, a user 2 with ID2 reserves a program on the channel 1, which is the same as in the item No. 8, by setting the starting date and time to Dec. 22, 2004, 08:00:00′ and the ending date and time to Dec. 22, 2004, 08:35:00′ with recording image quality SP.

At this time, the controller 34 changes the starting date and time and the ending date and time in the item No. 8 of the video recording reservation list to those designated by the user 2, and adds “ID2” to the item under “Id”.

That is, the starting time and the ending time are set such that they cover a maximum common period between two different reservations with different IDs.

In practice, the recording is performed from Dec. 22, 2004, 08:00:00′ to Dec. 22, 2004, 08:35:00′ with image quality SP, as shown in the list.

In the stored-information list, the starting time and the ending time reserved by each user are recorded in association with each ID (not shown), and therefore the recorded information defined by the starting time and the ending time is reproduced only for the user with the ID associated with the starting time and the ending time.

In a case where both the time period for video recording and the recording image quality are different between the reservations, the higher image quality may be adopted for the video recording at least during the period common to the reservations, and the image quality respectively selected by each of the reservations may be adopted outside of the common period.

Of course, it is also possible to perform recording over the whole period with image quality which is selected for the common period.

Explained next is a case where a user 2 is to record data in a digital video camera on the server 3, whereas the data has already been recorded on the server 3 by a user 1.

The situation described-above may occur when a plurality of user shares one digital video camera.

For example, there may be a case where the user 2 is about to use the digital video camera to find that a tape (or a disk, etc.) in the digital video camera is full but the user 2 cannot make sure whether the user 1 who has taken images by using the tape has already recorded the data on the images on the server 3.

There may be another case where the user 2 just wants to transfer the data tentatively onto the server.

The user 2 in front of the display 2 connects the digital camera to the display 2 and operates the display 2 through a remote controller or the like such that the data is recorded on the server 3.

Operation information is sent to the server 3, together with the ID of the display 2, through the network 4.

The controller 34 in the server 3 receives the recorded data from the display 1 and, based on the operation information, starts to add the image information of the digital video camera and the ID to the reproduction list including all the information.

At this time, according to the stored-information list which is provided as the one shown in the table, the data to be stored by the user 2 has already been stored by the user 1 as the item No. 7 in the list.

The controller 34 detects that the data has already been stored in the reproduction list, and therefore does not perform actual recording of the data but adds the ID of the user on the reproduction list.

That is, “ID2” of the user 2 (display 2) is added to the item No. 7 under the heading of “ID”.

The actual recording of the data is performed only once when the user 1 requested it first.

File information (such as image taking time or file size) included in the images in the digital video camera may be used to determine whether the data are identical to the data which has already stored in the server.

Both of the users can reproduce the information thus recorded by using the reproduction list.

In this example, operation of recording the information obtained through a digital video camera is explained, but the same operation can be applied for recording the information obtained through a digital camera.

Explained next is a case of copying and transferring information assigned IDs of a plurality of users to the optical disk.

The user 2 in front of the display 2 operates the display 2 through a remote controller or the like to cause the display 2 to display the reproduction list, in order to copy and transfer the information stored by that time from the HDD to the optical disk.

Operation information is sent to the server 3, together with the ID of the display 2, through the network 4.

The controller 34 in the server 3 refers to the operation information sent thereto so as to extract, from the list including all the information stored in the server 3, only items of information stored under the ID of the display 2. The controller 34 then sends back the extracted items of information as a list to the display 2 through the network 4.

At this time, according to the stored-information list which is provided as the one shown in the table, the list to be sent back to the user 2 includes the items No. 2, No. 3, No. 5, No. 6, No. 8, No. 10, and No. 11.

The user 2 copies data from the HDD to the ODD this time.

The user 2 selects items of information to be copied from the items listed in the reproduction list displayed on the display.

For example, the user 2 selects the item No. 8 at this time.

The selected information is sent to the server 3 together with the ID of the display through the network 4.

Based on the sent ID and the selected information, the controller 34 copies the item No. 8 of information onto the ODD (optical disk) while adding “ODD” under the heading of “storage area” in the stored-information list.

The controller 34 sends the reproduction list in which “ODD (optical disk)” is added to the selected information to the display associated with the ID through the network 4.

The user 2 referring to the display on the display 2 confirms that the selected item has been copied.

At this time, in the stored-information list, each ID and the storage area are associated with one another and managed. Therefore, when the user 1 has the reproduction list displayed on the display 1, the list is displayed as if the item No. 8 is stored only in the HDD.

In the case of transferring the data, if the data is stored in the HDD under another ID (in this case, display 1), the data is copied in the actual operation.

Even in this case, each user can distinguish on the list displayed to each user whether the data has been copied or transferred, because the list is managed such that the ID and the storage information are associated with each other.

For example, in the item No. 8 in the table, it is displayed for the user 1 with ID1 as if the item No. 8 is still stored in the HDD, while it is displayed for the user 2 with ID2 as if the item No. 8 is stored in the ODD.

In the case where the information, which has already been transferred by the ID2 from the HDD to the ODD, is transferred by the ID1 from the HDD to the ODD, the data has actually been already copied from the HDD to the ODD, and therefore the data is actually deleted from the HDD. At the same time, the reference of HDD under the heading of “storage area” in the stored-information list is also deleted.

That is, the copying of the data from the HDD to the ODD was actually performed only once when the user 2 requested it, and the transfer (deletion) of the data from the HDD is also performed only once when the user 1 requested it.

In the example described above, the data is copied or transferred from the HDD to the ODD (optical disk), but it is also possible to copy and transfer the data from the ODD (optical disk) to HDD in the similar manner by interchanging the copy/transfer destination and the copy/transfer source.

As described above, the embodiment of the present invention has been explained, but the list shown in the table is merely an example according to the present invention, and the present invention is not limited thereto.

Also, according to this embodiment, an explanation is given of the case where the number of users is two. However, the same method can be applied to a case where the number of users is two or more.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-364813, filed Dec. 19, 2005 which is hereby incorporated by reference herein in its entirety.

What is claimed is:

1. An information recording and reproducing apparatus capable of reserving video recording, comprising:
a tuner for receiving a broadcasting program;
recording means for performing video recording the broadcasting program; and
a controller for managing video recording reservations and controlling the recording means,
wherein the controller jointly owns and records video recording information in an overlapping part of the video recording reservations when contents of the video recording reservations made by a plurality of users overlap one another at least in part.

2. The apparatus according to claim 1, wherein the recording means comprises an optical disk device.

3. The apparatus according to claim 1, wherein the recording means comprises a hard disk device.

4. The apparatus according to claim 1, wherein the video recording reservation includes an ID of a user who has made the video recording reservation.

5. The apparatus according to claim 1, further comprising a plurality of displays each assigned an individual ID, wherein the video recording reservation includes the ID.

6. The apparatus according to claim 1, wherein the video recording reservations each include information on image quality regarding images to be recorded; and the video recording as to the overlapping part of the video recording reservations is performed based on the information having higher image quality.

7. The apparatus according to claim 1, wherein the contents of the video recording reservations overlappping each other in part is video recording time reserved by the video recording reservations.

8. A method of recording and reproducing information capable of reserving video recording, comprising the steps of:
receiving a video recording reservation; and
jointly owning and recording video recording information in an overapping part of the video recording reservations when the content of the video recording reservation overlaps at least a part of a content of another video recording reservation which has already been accepted.
